(19) United States
(12) Patent Application Publication
(10) Pub. No.: US 2021/0339506 A1
(43) Pub. Date: Nov. 4, 2021

(54) SHEETS OF POLYMERIZED SILOXANE AND RELATED METHODS FOR PROVIDING INSULATION BETWEEN AN INTERIOR OF AN ENCLOSURE AND OUTSIDE OF A WINDOW

(71) Applicant: My Inspiration, LLC, Raleigh, NC (US)

(72) Inventor: Ivonne Olguin, Raleigh, NC (US)

(21) Appl. No.: 16/939,174

(22) Filed: Jul. 27, 2020

Related U.S. Application Data
(60) Provisional application No. 63/017,932, filed on Apr. 30, 2020.

(51) Int. Cl. B32B 17/10; E06B 3/67; B32B 17/06

(52) U.S. Cl. CPC B32B 17/10798; E06B 3/6715; B32B 17/064; B32B 2250/02; B32B 2383/00; B32B 2307/304; B32B 17/10027

(57) ABSTRACT

Sheets of polymerized siloxane and related methods for providing insulation between an interior of an enclosure and outside of a window are disclosed. According to an aspect, a method includes providing a sheet of polymerized siloxane. The method also includes placing the sheet to at least substantially cover a pane of a window of an enclosure. Further, the method includes attaching the placed sheet to the window for providing insulation between an interior of the enclosure and outside of the window.

### CROSS REFERENCE TO RELATED APPLICATION

This application claims priority to U.S. Patent Application No. 63/017,932, filed Apr. 30, 2020, and titled “Window Insulator”, the content of which is incorporated herein by reference in its entirety.

### TECHNICAL FIELD

The presently disclosed subject matter relates generally to systems and methods for improving energy efficiencies of buildings. Particularly, the presently disclosed subject matter relates to sheets of polymerized siloxane and related methods for providing insulation between an interior of an enclosure and outside of a window.

### BACKGROUND

Energy efficiency is an important consideration of house design and upgrades. Modern houses and other occupied buildings are generally well insulated so that there is not substantial thermal energy transfer between the house interior and the outside. However, there remains significant thermal energy transfer through windows. Windows especially result in energy inefficiencies when temperature differences between the outside and inside are significant such as during the summer and winter.

Various techniques and constructions have been made to improve the energy efficiencies of windows. For example, modern windows are often double paned and sealed better such that thermal energy transfer is reduced. However, these improvements can add to the costs of the windows and these extra costs must be weighed against the resulting energy efficiency savings.

Shrink film window insulation kits are also available for application to windows for improving efficiency. These kits include a sheet of shrink film that is made of plastic. In order to install, the sheet must be cut to window size and applied to the window on its adhesive side. Next, a hair dryer must be used to smooth wrinkles in the film and to remove air bubbles between the film and window. It has been found that the use of this material and technique has difficulties in applying the film to the window and the resulting product. For example, the film can be difficult to cut to a desired size, difficult to attach, and difficult to clean.

In view of the foregoing, there is a continuing need for improved systems, materials, and techniques for insulating windows.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a front view of a window of an enclosure with a sheet of polymerized siloxane being applied thereto in accordance with embodiments of the present disclosure;

FIG. 2 is a flow diagram of a method of insulating a window with a sheet of polymerized siloxane in accordance with embodiments of the present disclosure; and

FIG. 3 is a front view depicting the sheet of FIG. 1 placed in position such that it cover the panes of the window in accordance with embodiments of the present disclosure.

### SUMMARY

The presently disclosed subject matter relates to sheets of polymerized siloxane and related methods for providing insulation between an interior of an enclosure and outside of a window. According to an aspect, a method includes providing a sheet of polymerized siloxane. The method also includes placing the sheet to at least substantially cover a pane of a window of an enclosure. Further, the method includes attaching the placed sheet to the window for providing insulation between an interior of the enclosure and outside of the window.

According to another aspect, a method includes providing a transparent sheet made of silicone. The method also includes sizing the sheet to fit a pane of a window of an enclosure. Further, the method includes placing the sheet to at least substantially cover the pane of the window. The method also includes adhering the sheet to the window for providing insulation between an interior of the enclosure and outside of the window.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

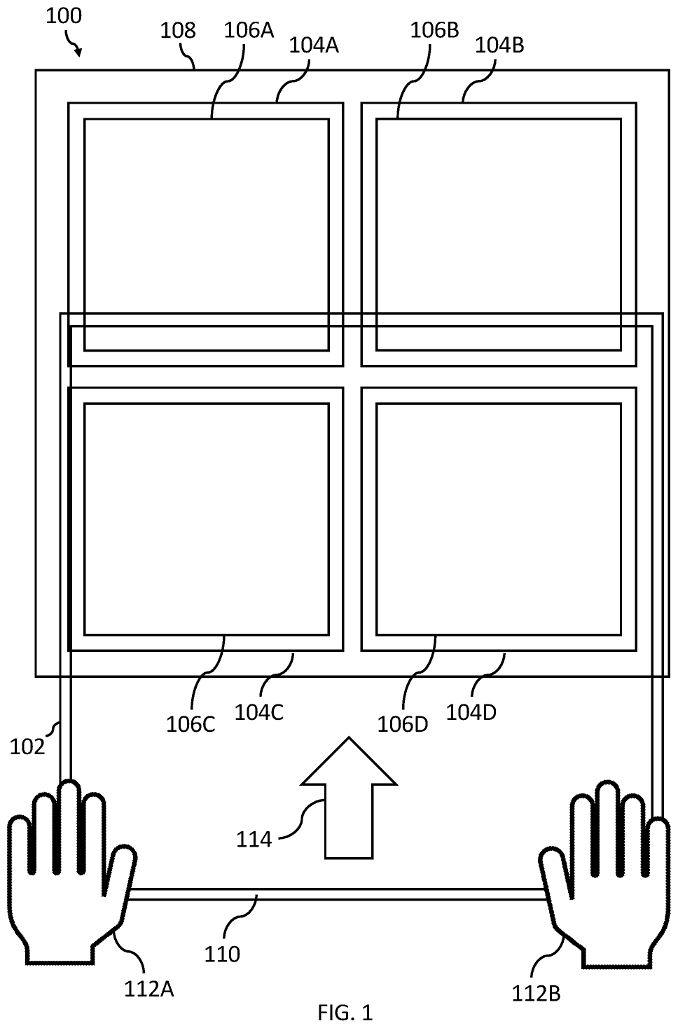

FIG. 1 illustrates a front view of a window, generally designated 100, of an enclosure with a sheet 102 of polymerized siloxane being applied thereto in accordance with embodiments of the present disclosure. Referring to FIG. 1, the enclosure is a house but may alternatively be any other suitable enclosure such as an office building, a commercial building or the like. It should also be understood that the enclosure may be any other suitable type of enclosure having a window, such as, but not limited to an automobile, boat, or other vehicle. The view provided in FIG. 1 is from a point inside the window 100, and the sheet 102 is depicted as being inside of the window 100 and a distance apart from the window 100 prior to its attachment to the window 100.

The window 100 is a window having four (4) panes 104A-104D that hold transparent glass 106A-106D, respectively. The panes 104A-104D and glass 106A-106D are rectangular in shape, although it should be understood that the panes and glass may be any other suitable shape and size. Further, it should be understood that the window 100 may be any suitable type of window having any suitable number of panes, etc. Structurally the panes 104A-104D and glass 106A-106D are held together by a frame 108 as will be understood by those of skill in the art.

With continuing reference to FIG. 1, the sheet 102 is transparent and made of polymerized siloxane. For example, the sheet 102 may be made of silicone or any other suitable type of insulative and transparent or semi-transparent material. The sheet 102 may be a silicone rubber sheet.

The sheet 102 may be configured to adhere or otherwise attach to the window 100. Particularly, the sheet 102 may be sealingly attached to the window 100 or at least attached to the window 100 such that it is partially sealingly attached to the window 100. Here, “sealingly attached” can mean that the sheet 102 is attached such that there is an interior formed by the sheet 102 and the window 100. The formed interior can provide an insulative layer between outside the window and the interior of the enclosure to reduce thermal transfer between outside the window and the interior of the enclosure. In an example and as described in further detail herein, one or more edges of the sheet 102 may be attached to the window 100 to substantially or entirely cover one or more panes 104A-104D (and thereby glass 106A-106D) of the window 100. In this example, the sheet 102 has an adhesive layer 110 around its edges that can be attached to the window 100 as described in more detail herein.

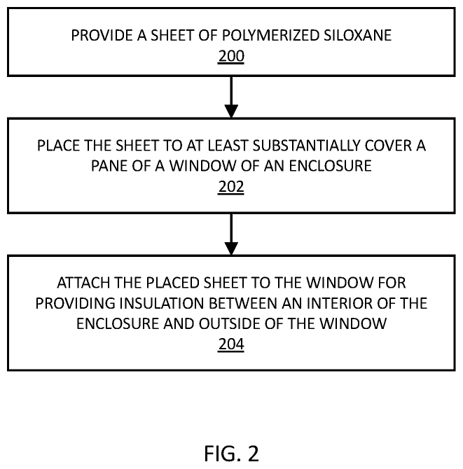

FIG. 2 illustrates a flow diagram of a method of insulating a window with a sheet of polymerized siloxane in accordance with embodiments of the present disclosure. This method is described by example with reference to FIG. 1, although it should be understood that this method may be similarly or otherwise suitably apply to attach a sheet of polymerized siloxane to another suitable window in accordance with the present disclosure.

Now referring to FIG. 2, the method includes providing 200 a sheet of polymerized siloxane. For example, the sheet 102 shown in FIG. 1 may be provided and placed near the window 100 as shown in FIG. 1. An installer's may grasp sides of the sheet 102 with his or her hands 112A and 112B in order to hold the sheet 102. Alternatively, for example, the sheet 102 may be held in place near the window 100 by any other suitable technique.

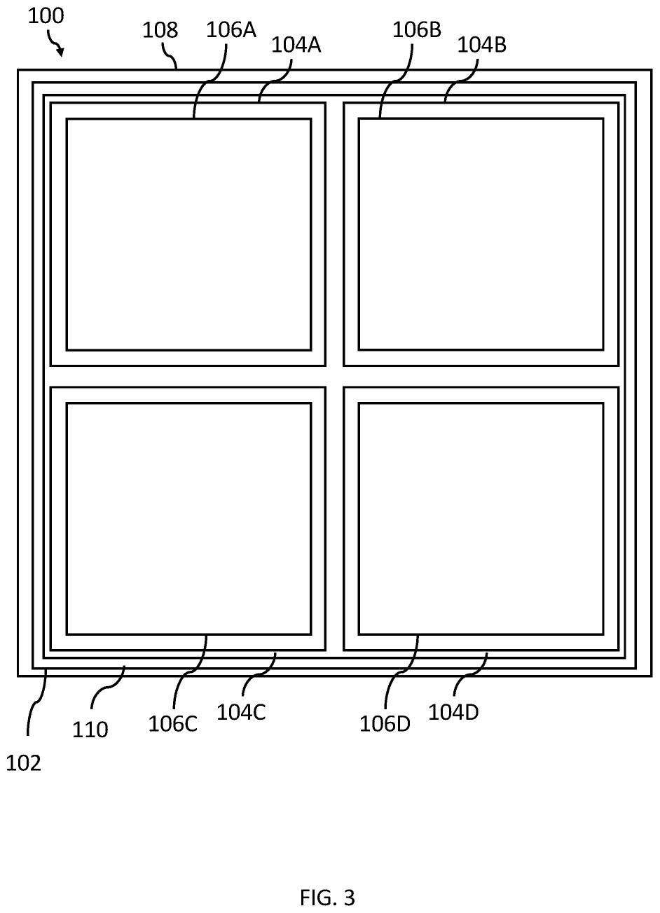

The method of FIG. 2 includes placing 202 the sheet to at least substantially cover a pane of a window of an enclosure. Continuing the example of FIG. 1, the installer may use his or her hands 112A and 112B to move the sheet 102 in a direction, represented by arrow 114, to cover the panes 104A-104D of the window 100. In this example, the sheet 102 is move generally in an upward direction (as indicated by arrow 114) such that it can be positioned to cover the panes 104A-104D. FIG. 3 illustrates a front view depicting the sheet 102 of FIG. 1 placed in position such that it cover the panes 104A-104D of the window 100 in accordance with embodiments of the present disclosure. As shown, all 4 of the panes 104A-104D and thereby also the glass 106A-106D of the window 100 are covered by the sheet 102.

The method of FIG. 2 includes attaching 204 the placed sheet to the window for providing insulation between an interior of the enclosure and outside of the window. Continuing the aforementioned example, all or at least part of the adhesive layer 110 of the sheet 102 can be attached to the frame 108 of the window 100. For example, subsequent to its placement as shown in FIG. 3 the adhesive layer 110 can be contacted, such as by a depressing force by the installer's hand or fingers, such that it sealingly attaches to the frame 108 or any other suitable part of the window 110 (e.g., the pane, the glass, etc.). Advantageously, the adhesive layer 110 in this example is around the edges of the sheet 102 such that it may only contact the frame 108 such that it forms the aforementioned insulative barrier between the sheet 102 and the window 100. As a result, insulation is provided between the interior of the enclosure and outside the window 100.

Alternative to an adhesive layer being on a side of the sheet, it is noted that any other suitable technique for attaching the sheet may be utilized. For example, double-sided or single-sided adhesive tape may be used in place of the adhesive layer or as a supplement to an adhesive layer for attaching the sheet to the window.

In accordance with embodiments, the sheet 102 may be manufactured of a size and shape for fitting to the window 100 as shown. In other examples, the sheet 102 may be sized and shaped by the installer to substantially match the edges of the pane or panes of the window 100. For example, the installer may measure the size and shape of the window and subsequently cut with scissors or otherwise suitably change the shape and size of the sheet for fitting to the window for attachment in accordance with embodiments disclosed herein. In this way a portion of the sheet may be removed such that the sheet can fit to the window in accordance with embodiments disclosed herein. The portion of the sheet can be suitably detached in this way and used on another window or discarded.

Experiments were conducted to demonstrate the effectiveness of using a sheet of polymerized siloxane as an insulative material when applied to windows in accordance with examples described herein. This material was shown to be very effective for insulating windows. With the sheet applied, the temperature of a space just inside a window with a sheet applied as described herein was 66.9° Fahrenheit (F). Without the sheet applied, the same space was recorded to have a temperature of 62.4° F. Therefore, the sheet applied to a window as described herein was shown experimentally to be very effective at insulating the window, thereby reducing the effective thermal transfer from outside an enclosure to inside the enclosure through the window.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A method comprising:
providing a sheet of polymerized siloxane;
placing the sheet to at least substantially cover a pane of a window of an enclosure; and
attaching the placed sheet to the window for providing insulation between an interior of the enclosure and outside of the window.

2. The method of claim 1, wherein providing the sheet comprises providing a sheet made of silicone.

3. The method of claim 1, wherein providing the sheet comprises providing a silicone rubber sheet.

4. The method of claim 1, wherein providing the sheet comprises providing the sheet with adhesive on a side thereof.

5. The method of claim 1, wherein the sheet is transparent or semi-transparent.

6. The method of claim 1, wherein edges of the sheet is sized to substantially match edges of the pane of the window.

7. The method of claim 1, wherein placing the sheet comprises substantially aligning edges of the sheet with edges of the pane of the window.

8. The method of claim 1, wherein attaching the placed sheet comprises using adhesive tape to attach the placed sheet to the window.

9. The method of claim 1, wherein the enclosure is a building or an automobile.

10. The method of claim 1, wherein attaching the placed sheet comprises adhering the sheet directly to the window.

11. The method of claim 1, wherein attaching the placed sheet comprises adhering the sheet directly to the pane of the window.

12. The method of claim 1, further comprising removing a portion of the sheet for fitting the sheet to the window.

13. The method of claim 12, wherein removing a portion of the sheet comprises cutting the portion of the sheet to detach the portion of the sheet from a remainder portion of the sheet.

14. A method comprising:
providing a transparent sheet made of silicone;
sizing the sheet to fit a pane of a window of an enclosure;
placing the sheet to at least substantially cover the pane of the window; and
adhering the sheet to the window for providing insulation between an interior of the enclosure and outside of the window.

15. The method of claim 14, wherein the sheet has adhesive on a side thereof, and wherein adhering the sheet comprises touching the adhesive to the window.

16. The method of claim 1, wherein adhering the sheet comprises using adhesive tape to attach the placed sheet to the window.

17. The method of claim 14, wherein placing the sheet comprises substantially aligning edges of the sheet with edges of the pane of the window.

18. The method of claim 14, wherein the enclosure is a building or an automobile.

19. The method of claim 14, wherein adhering the sheet comprises adhering the sheet directly to the pane of the window.

20. A window insulation comprising:
a transparent sheet made of silicone sized to fit to a pane of a window of an enclosure, the sheet having a first side for facing away from the window, and a second side for facing towards the window; and
an adhesive layer attached to the second side of the sheet.
